(19) United States
(12) Patent Application Publication
(10) Pub. No.: US 2011/0287750 A1
(43) Pub. Date: Nov. 24, 2011

(54) LINK SERVER AND PROGRAM THEREOF, WEBSITE BROWSING SYSTEM, WEBSITE BROWSING METHOD, AND WEBSITE BROWSING PROGRAM

(75) Inventors: Kentaro WATANABE, Tokyo (JP); Hironori Yano, Tokyo (JP)

(73) Assignee: FUJIFILM Corporation, Tokyo (JP)

(21) Appl. No.: 13/109,549

(22) Filed: May 17, 2011

(30) Foreign Application Priority Data
May 21, 2010 (JP) 2010-117230

(51) Int. Cl. H04L 29/06

(52) U.S. Cl. 455/414.3

(57) ABSTRACT

In response to a browsing request of a website from a mobile phone, a link server acquires content information from the web server. Based on the content information, a plurality of page images generated by making a picture of the web page, pseudo UIF display data corresponding to UIF included in the web page, URL information indicating URL address of a top page of the website to be browsed, and a control code for providing the mobile phone with various functions related to the website browsing are combined, and thereby generating a website browsing application. The link server delivers the generated website browsing application to the mobile phone.

### BACKGROUND OF THE INVENTION

1. Field of the Invention

The present invention relates to a link server that generates an image of a web page of a predetermined website and allows a browse of this image on a mobile terminal and a program of the link server, a website browsing system, a website browsing method, and a website browsing program for the mobile phone.

2. Description of the Related Art

There is an increasing need for browsing websites on mobile phones by accessing to the internet. According to this trend, the number of models of mobile phones having a full browser, which allows a browse of websites designed for PC browsers, has been increasing.

The full browser may be of a native type and an application type. The native full browser renders a web page of a website for the PC on the mobile phone and allows a browse of the website for the PC. The application full browser has a link server between the mobile phone and the web server. The link server converts the web page of the website for the PC into a web page for the mobile phone, and the converted web page is delivered to the mobile phone, thereby allowing a browse of the website for the PC.

However, since the amount of communication data and the amount of data processed on the mobile phone increase when using the native full browser, display speed may decrease and communications cost may increase. On the other hand, layout of the website for the PC cannot completely be reproduced on the mobile phone when using the application full browser, and therefore the layout displayed on the mobile phone may be different from the PC monitor.

In order to solve the above problems, there is proposed a website browsing system in which a link server having functions to render the web page of the website for the PC and to convert the web page to image data is placed between the mobile phone and the web server (for example, Japanese Patent Laid-Open Publication No. 2004-220260). For this configuration, the web page of the website for the PC is converted into images (hereinafter, referred to as page image) that can be displayed on the mobile phone, and delivered to the mobile phone.

If the web page is delivered after being converted into the image data, the amount of communication data is reduced as compared to the case of delivering various types of information for rendering the web page, and complicated processing such as the rendering can be omitted. Owing to this, the amount of data processed on the mobile phone can be reduced, and content of the website for the PC can be browsed on the mobile phone without decreasing the display speed nor increasing the communications cost. Moreover, since the mobile phone performs only the processing to display the received page image, the displayed layout on the mobile phone is the same as the PC monitor, unlike the case of performing the rendering on the mobile phone.

The web page is provided with various user interface elements (hereinafter, abbreviated to UIF) such as text input box and link. However, functions of such UIF are lost when the web page is converted into the image data. In view of this, it is proposed that information of each UIF included in the web page is delivered along with the page image from the link server to the mobile phone in the website browsing system of the Japanese Patent Laid-Open Publication No. 2004-220260.

Upon receiving each piece of information from the link server, the mobile phone displays the page image on a screen, and also generates a pseudo UIF having a comparable function as the UIF in the web page based on the information of each UIF and superposes the pseudo UIF at a corresponding position on the page image. Owing to this, an operation instruction can be input to each pseudo UIF, like the web page, even if the web page is delivered after being converted into the image data.

When the operation instruction is input to the pseudo UIF, the mobile phone sends information of this pseudo UIF and information indicating the content of the operation instruction to the link server. Upon receiving the information indicating that the pseudo UIF is operated, the link server sends the information to the web server of the website that is targeted for browsing. Owing to this, the operation instruction input to the pseudo UIF is reflected on the actual website.

When particular website is often browsed on the mobile phone, it is inefficient to receive the page image and information of each UIF every time the website is browsed, because the communication wait time and communications cost for reception of each piece of information arise every time.

In order to solve the above problem, it is possible to store the page image and information of each UIF once received on the mobile phone. If such stored information is displayed in browsing the corresponding website next time, the communication wait time and communications cost can be reduced from the second time on.

In relation to this, for example, it is disclosed in U.S. Pat. No. 7,359,736 (corresponding to Japanese Patent Laid-Open Publication No. 2004-274566) that web page and the like displayed on a display section are stored as image data using the screen capture function. Moreover, it is disclosed in Japanese Patent Laid-Open Publication No. 2006-323730 that image data once sent is stored, and thereby reducing the communications cost.

However, the relevancy between each piece of information and the website cannot be recognized by the mobile phone and the link server only by storing the page image and information of each UIF. Therefore, even though the content of the corresponding website is browsed, the operation instruction input to the pseudo UIF cannot be reflected on the actual website according to the method for merely storing the received information on the mobile phone.

Thus, according to the method for storing the received information on the mobile phone, even though the communication wait time and communications cost can be reduced in browsing the same website for the second time and subsequent times, the important function in the above website browsing system, which is to reflect the operation to the pseudo UIF on the actual website, is lost.

### SUMMARY OF THE INVENTION

An object of the present invention is to reduce communication wait time and communications cost in a website browsing system without lowering functions thereof when browsing the same website for more than two times.

To achieve the above and other objects of the present invention, a link server according to the present invention that is connected to a mobile phone and a web server through a network includes a content information acquisition section, a rendering section, an image converter, a pseudo UIF display data generating section, an application generating section and a delivery section. The content information acquisition section acquires content information for constructing a web page of a website of which a browsing is requested from the mobile terminal. The rendering section renders the web page from the content information. The image converter generates a page image corresponding to the web page by converting the web page into image data. The pseudo UIF display data generating section obtains UIF information, which is for constructing a UIF in the web page, of every UIF included in the web page from the rendering result of the web page. Based on the UIF information, the pseudo UIF display data generating section generates pseudo UIF display data for displaying a pseudo UIF having a comparable function as the UIF on the page image. The application generating section generates an application that enables a browse of content of the web page as the page image on the mobile terminal. The application has at least a control code for providing the mobile phone with a function to enable an input of an operation instruction as browsing the rendered web page by displaying the pseudo UIF on the page image. The delivery section delivers the application, website information indicating the website to be browsed, the page image corresponding to this website, and the corresponding pseudo UIF display data to the mobile phone.

It is preferable that the control code further provides the mobile phone with a function to send at least the website information to the link server, a function to make a display section of the mobile phone display the page image, and a function to input the operation instruction to the pseudo UIF through an operation section of the mobile phone.

It is preferable that the application generating section includes the pseudo UIF display data in the application, and the delivery section delivers the pseudo UIF display data as the application.

It is also preferable that the application generating section includes the website information and the corresponding web page in the application, and the delivery section delivers the website information and the page image as the application.

It is preferable that the application generating section combines the website information with the corresponding web page as external data, and the delivery section delivers the application and the external data to the mobile phone. When the page image is combined as the external data, it is preferable that the application generating section encrypts the page image so that the page image is decrypted only when the application is started.

It is preferable that the application displays the page image only when instructed by the link server.

A program of a link server of the present invention that is connected to a mobile phone and a web server through a network makes the link sever perform the steps of: acquiring content information for constructing a web page of a website of which a browsing is requested from the mobile terminal; rendering the web page from the content information; generating a page image corresponding to the web page by converting the web page into image data; obtaining UIF information, which is for constructing a UIF in the web page, of every UIF included in the web page from the rendering result of the web page, and generating, based on the UIF information, pseudo UIF display data for displaying a pseudo UIF having a comparable function as the UIF on the page image; generating an application that enables a browse of content of the web page as the page image on the mobile terminal; and delivering the application, website information indicating the website to be browsed, the page image corresponding to this website, and the corresponding pseudo UIF display data to the mobile phone. The application has at least a control code for providing the mobile phone with a function to enable an input of an operation instruction as browsing the rendered web page by displaying the pseudo UIF on the page image.

A website browsing system according to the present invention includes the mobile terminal for requesting a browse of the website and the link server that is connected to the mobile phone and the web server through the network.

A website browsing method according to the present invention includes the steps of: acquiring content information for constructing a web page of a website of which a browsing is requested from the mobile terminal; rendering the web page from the content information; generating a page image corresponding to the web page by converting the web page into image data; obtaining UIF information, which is for constructing a UIF in the web page, of every UIF included in the web page from the rendering result of the web page, and generating, based on the UIF information, pseudo UIF display data for displaying a pseudo UIF having a comparable function as the UIF on the page image; generating an application that enables a browse of content of the web page as the page image on the mobile terminal; and delivering the application, website information indicating the website to be browsed, the page image corresponding to this website, and the corresponding pseudo UIF display data to the mobile phone. The application has at least a control code for providing the mobile phone with a function to enable an input of an operation instruction as browsing the rendered web page by displaying the pseudo UIF on the page image.

A website browsing program for a mobile phone according to the present invention makes the mobile terminal realize the functions of: holding website information indicating the website to be browsed and the page image corresponding to this website; sending the website information to the link server; making a display section of the mobile phone display the page image; generating the pseudo UIF based on the pseudo UIF display data, and superposing the pseudo UIF at a corresponding position on the page image; and inputting the operation instruction to the pseudo UIF through an operation section of the mobile phone.

According to the present invention, the application having the control code which provides the mobile phone with various functions related to the website browsing, and merging the website information indicating the website to be browsed and the page image corresponding to the website with the control code is generated and delivered to the mobile phone. Owing to this, the page image can be displayed on the mobile phone, like when receiving the page image from the link server, by starting the application and controlling based on the control code. Since the website information indicating the website to be browsed is merged, the relevancy between the page image and the website can be recognized by the mobile terminal and the link server with ease. Therefore, according to the present invention, it is possible to reduce the communication wait time and communications cost without lowering various functions related to the website browsing when browsing the same website for more than two times.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is an explanatory view illustrating a configuration of a website browsing system;

FIG. 2 is an explanatory view schematically illustrating a website browsing procedure;

FIG. 3 is a block diagram schematically illustrating a configuration of a mobile phone;

FIG. 4 is a block diagram schematically illustrating a configuration of a link server;

FIG. 5 is a flowchart illustrating an application generation procedure;

FIG. 6 is a flowchart illustrating a website browsing procedure;

FIG. 7 is a flowchart illustrating an example that only a page image is incorporated;

FIG. 8 is a flowchart illustrating an example that various types of information are combined as external data; and

FIG. 9 is a flowchart illustrating an example that a UIF operation signal is sent to the link server altogether after completing the browsing.

### DESCRIPTION OF THE PREFERRED EMBODIMENTS

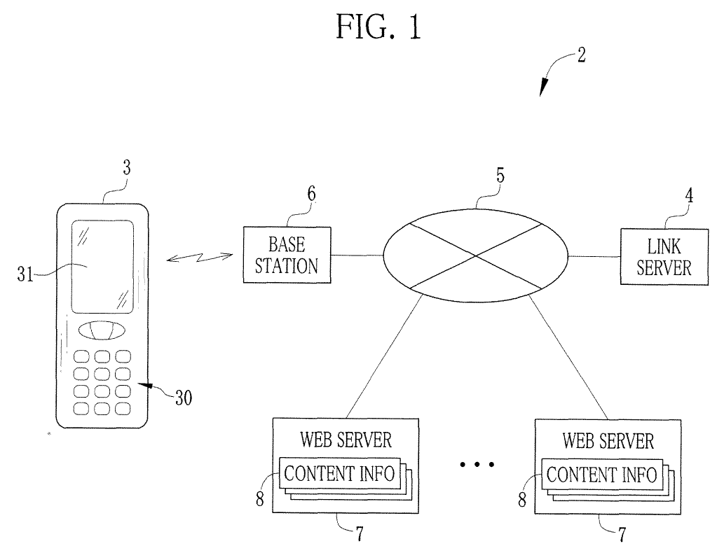

A website browsing system 2 as shown in FIG. 1 is constituted of a mobile phone (mobile terminal) 3 and a link server 4. The link sever 4 is connected to an internet 5 which is a public network. The mobile phone 3 can be connected to the internet 5 via a base station 6 by wirelessly communicating with the base station 6. The mobile phone 3 accesses to the link sever 4 via the base station 6 and the internet 5, and thereby communicating with link server 4.

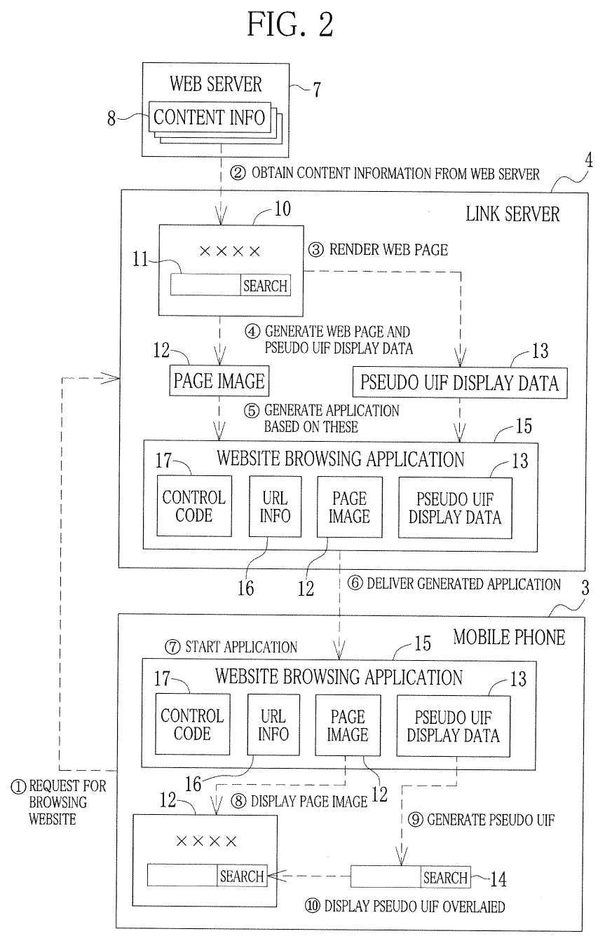

A plurality of web servers 7 that provides websites is connected to the internet 5. The website provided by the web server 7 includes a plurality of web pages 10 (see FIG. 2). Each web server 7 stores plural pieces of content information 8. Each piece of content information 8 is used for rendering the web page 10 and corresponds to each web page 10 of the web server 7.

The content information 8 includes HTML data, CSS data and images related to the HTML data, and the like. The content information 8 is designed for a web browser of a personal computer (hereinafter, referred to as the PC). Note that the content information 8 may be described in other markup languages than the HTML. Moreover, the CSS data and images may be stored in a different server.

The web page 10 for the PC cannot be displayed on a browser of the mobile phone 3. Even if the web page 10 is displayed, the layout may often be different from the layout on the PC monitor due to difference in screen size. In the website browsing system 2, the link server 4 is placed between the mobile phone 3 and the web server 7, and a processing for converting the web page 10 for the PC in a format to be displayed on the mobile phone 3 is performed by the link server 4. Owing to this, the web page 10 for the PC can be browsed on the mobile phone 3 as being displayed on the PC monitor.

The mobile phone 3 is provided with an operation section 30 for inputting various operation instructions and a liquid crystal display (LCD) 31 for displaying various screens in response to the operation instructions from the operation section 30. As shown in FIG. 2, to browse the website of the web server 7 on the mobile phone 3, a user starts the browser by operating the operation section 30 and sends a URL address of a top page of the website that the user wants to browse via the browser to the link server 4, thereby requesting a browse of this website to the link server 4.

When the browsing of the website is requested from the mobile phone 3, the link server 4 accesses to the web server 7 corresponding to the URL address included in the request, and acquires each piece of content information 8 from the web server 7. When each piece of content information 8 is acquired, the link server 4 renders the web page 10 based on each piece of content information 8. After rendering each web page 10 corresponding to each piece of content information 8, the link server 4 converts each web page 10 into image data that can be displayed on the mobile phone 3, thereby generating a plurality of images (hereinafter, referred to as page image) 12 corresponding to each web page 10.

The web page 10 is provided with various user interface (UIF) elements 11 such as text input box, check box, button, link, and the like. After rendering the web page 10, the link server 4 generates pseudo UIF display data 13 corresponding to each UIF 11 included in the web page 10 while generating the page image 12.

The pseudo UIF display data 13 is data for displaying a pseudo UIF 14 having a comparable function as the UIF 11 on the page image 12. The link server 4 generates the pseudo UIF display data 13 corresponding to the UIF 11 based on UIF information, which is for constructing the UIF 11 on the web page 10.

The UIF information indicates, for example, ID for uniquely identifying the UIF 11, coordinate information indicating a position of the UIF 11 on the web page 10, display size of the UIF 11 on the web page 10, format of the UIF 11, URL address of link, attribute value of the HTML tag of the UIF 11, and the like. The link server 4 obtains the UIF information of each UIF 11 from the rendering result of the web page 10, and generates the corresponding pseudo UIF display data 13 based on each piece of the UIF information.

The comparable function as the UIF 11 means a function seen from the user side. In a case when the UIF is the text box, the function means that text can be input in a box. In a case when the UIF is the check box, the function means that a check can be displayed in a box in response to a click.

After generating the page image 12 and pseudo UIF display data 13 of each web page 10, the link server 4 generates a website browsing application 15 that enables a browse of the website for the PC on the mobile phone 3 based on the generated page image and pseudo UIF display data 13. The website browsing application (website browsing program) 15 is constituted of each page image 12, each piece of pseudo UIF display data 13, URL information (website information) 16 for indicating URL address of the top page of the website to be browsed, and control code 17 for providing the mobile phone 3 with various functions related to the website browsing. The website browsing application 15 displays each page image 12 and each pseudo UIF 14 under the control of the control code 17. Owing to this, the website for the PC in the web server 7 can be browsed on the mobile phone 3 without communicating with the web server 7.

After generating the website browsing application 15, the web server 4 delivers the website browsing application 15 to the mobile phone 3 which has made the request. After completion of the reception of the website browsing application 15 delivered from the link server 4, the website browsing application 15 is started by operating the operation section 30.

When the startup of the website browsing application 15 is instructed, the mobile phone 3 reads the control code 17 included in the website browsing application 15. While making a control based on the description in the control code 17, the mobile phone 3 makes the LCD 31 display each page image 12 included in the website browsing application 15. At the same time, the mobile phone 3 generates the UIF 14 corresponding to each piece of pseudo UIF display data 13 included in the website browsing application 15 and superposes each of the generated pseudo UIF 14 at a corresponding position (position where the corresponding UIF 11 is displayed) on the page image 12.

Since each page image 12 is thus displayed on the LCD 31, the content of the web page 10 for the PC can be browsed on the mobile phone 3 in the same layout as displayed on the PC monitor. If the web page 10 is converted into the page image 12, the function of the UIF 11 is lost. However, since the pseudo UIF 14 corresponding to the UIF 11 of the web page 10 is displayed as being superposed on the page image 12, the operation instruction can be input to each pseudo UIF 14, like on the web page 10 of HTML data, even when browsing the content of the web page 10 in the page image 12.

After the page image 12 and each pseudo UIF 14 are displayed on the LCD 31, the operation instruction can be input to the pseudo UIF 14 from the operation section 30. According to the content of the operation instruction, the display of the page image 12 and each pseudo UIF 14 are switched. For example, when the operated pseudo UIF 14 is a link to jump to another web page 10 in the website, the display of the LCD 31 switches to the page image 12 and each pseudo UIF 14 corresponding to the web page 10 that the link represents. When the pseudo UIF 14 is the check box or a pull-down menu, the display of the UIF 14 is switched according to the input operation instruction. The operation instruction to the UIF 14 means the common operation performed during the browsing of the web page 10 such as to click, text input, mouseover, and the like.

When the operation instruction is input to the pseudo UIF 14 on the mobile phone 3, a UIF operation signal indicating the operated pseudo UIF 14 and the content of the operation are sent from the mobile phone 3 to the link server 4. Upon receiving the UIF operation signal, the link server 4 analyzes the operation instruction of the mobile phone 3 based on the UIF operation signal. When the analysis result is sent to the corresponding web server 7, the operation instruction in the website browsing application 15 is reflected to the actual website.

For example, it is assumed that the website browsing application 15 corresponds to a website for managing attendance in a company. When information about arrival time at work is input to the pseudo UIF 14 for inputting arrival time at work displayed on the page image 12, the information as the UIF operation signal is sent to the link server 4 from the mobile phone 3. Upon receiving the UIF operation signal, the link server 4 analyzes from the UIF operation signal that the information about arrival time at work is input, and sends it to the corresponding web server 7. Owing to this, the information about the arrival time at work is input to the website in the same manner as the information about the arrival time at work is input to the UIF 11 at the website by accessing to the web server 7, and thus the operation instruction in the website browsing application 15 is reflected on the actual website.

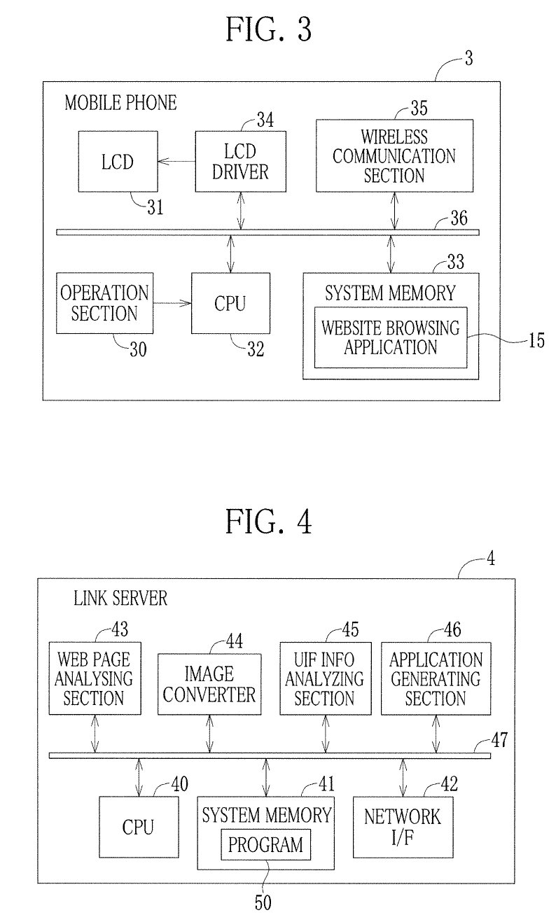

In addition to the operation section 30 and the LCD 31, the mobile phone 3 is provided with a CPU 32, a system memory 33, an LCD driver 34 and a wireless communication section 35 as shown in FIG. 3. These components are connected to one another via a data bus 36.

The system memory 33 stores various programs for controlling the mobile phone 3 and other data. In addition, the system memory 33 temporarily stores data generated during the control of the mobile phone 3. As the system memory 33, nonvolatile memory such as flash memory is used so that the data will not be lost in case the power is turned off. The CPU 32 reads programs from the system memory 33 and successively executes the programs and processes the data, and thereby taking overall control of each component of the mobile phone 3.

In addition, the website browsing application 15 delivered from the link server 4 is stored in the system memory 33. Owing to this, the website of which the browsing is once requested can be repeatedly browsed only by starting the website browsing application 15 in the system memory 33, and therefore there is no need to receive the page image 12 every time the website is browsed. Thus, the volume of the communication data for browsing the website and its communications cost can be significantly cut down.

The operation section 30 is connected to the CPU 32. The operation section 30 is constituted of a plurality of operation input members provided to be exposed on an exterior of the mobile phone 3. The operation instruction by the operation section 30 is input to the CPU 32. The operation input members include known input members such as push button switch, slide switch, arrow key, jog dial (rotatable selector), touch panel, and the like.

The LCD driver 34 reads the image data from the system memory 33 in response to the control signal from the CPU 32 and converts the image data into an analogue composite signal, and then outputs it to the LCD 31. The CPU 32 sends the control signal to the LCD driver 34 according to the instruction input from the operation section 30 and makes the LCD 31 display various screens. The wireless communication section 35 communicates wirelessly with the base station 6 and sends or receives data from or to the base station 6.

As shown in FIG. 4, the link server 4 is provided with a CPU 40, a system memory 41, a network interface (I/F) 42, a web page analyzing section 43, an image converter 44, a UIF information analyzing section 45 and an application generating section 46. These components are connected to one another via a data bus 47.

The system memory 41 stores a program 50 for controlling the link server 4 and other data. In addition, the system memory 41 temporarily stores data generated during the control of the link server 4. The CPU 40 reads a program 50 from the system memory 41 and successively executes the program and processes the data, and thereby taking overall control of each component of the link server 4.

The network I/F (delivery section) 42 is a known modem or a router and connects the link server 4 to the internet 5. The web page analyzing section 43 is the so-called rendering engine that analyzes the content information 8 acquired from the web server 7, and thereby rendering the web page 10 corresponding to the content information 8.

According to the instruction from the CPU 40, the image converter 44 converts the web page 10 rendered by the web page analyzing section 43 into the image data, and thereby generating the page image 12 corresponding to the web page 10. The page image 12 corresponding to the web page 10 is generated by converting the web page 10 into the image data using, for example, the known virtual printing technique. In addition, the image converter 44 writes URL information indicating URL address of the web page 10 of which the page image 12 is based on at a header of the page image 12 at the time of generating the page image 12. Owing to this, the page image 12 is related to the based web page 10.

Based on the analysis result by the web page analyzing section 43, the UIF information analyzing section 45 obtains the UIF information of each UIF 11 included in the web page 10 and generates the pseudo UIF display data 13 corresponding to each UIF 11 based on each piece of the UIF information. At this time, the UIF information analyzing section 45 writes URL information indicating URL address of the based web page 10 at a header of the pseudo UIF display data 13. Owing to this, the pseudo UIF display data 13 is related to the based web page 10.

When the UIF operation signal is received from the mobile phone 3, the UIF information analyzing section 45 identifies the UIF 11 corresponding to the operated pseudo UIF 14 and analyzes the content of the operation based on the UIF operation signal. The CPU 40 sends the analysis result by the UIF information analyzing section 45 to the corresponding web server 7. Owing to this, the operation instruction in the website browsing application 15 is reflected on the actual website of the web server 7.

According to the instruction from the CPU 40, the application generating section 46 generates the website browsing application 15. The application generating section 46 is provided with a general-purpose application constituted only of the control code 17. The application generating section 46 incorporates each page image 12 generated by the image converter 44 and each piece of pseudo UIF display data 13 generated by the UIF information analyzing section 45 into the general-purpose application. At the same time, the application generating section 46 generates the URL information 16 based on the URL address of the top page included in the browsing request from the mobile phone 3. The website browsing application 15 is generated by incorporating the URL information 16 into the general-purpose application thus integrating each piece of information with the control code 17.

When incorporating each page image 12 and each piece of pseudo UIF information display data 13 into the general-purpose application, the application generating section 46 encrypts them, so that they are decrypted only when an appropriate processing is performed based on the control code 17. Since the page image 12 is thus kept not being browsed easily by the encryption, risk of a leakage of information of the website not accessible to the public, such as a company website that can be browsed only by the employees, can be reduced even when the website is held as the application on the mobile phone 3.

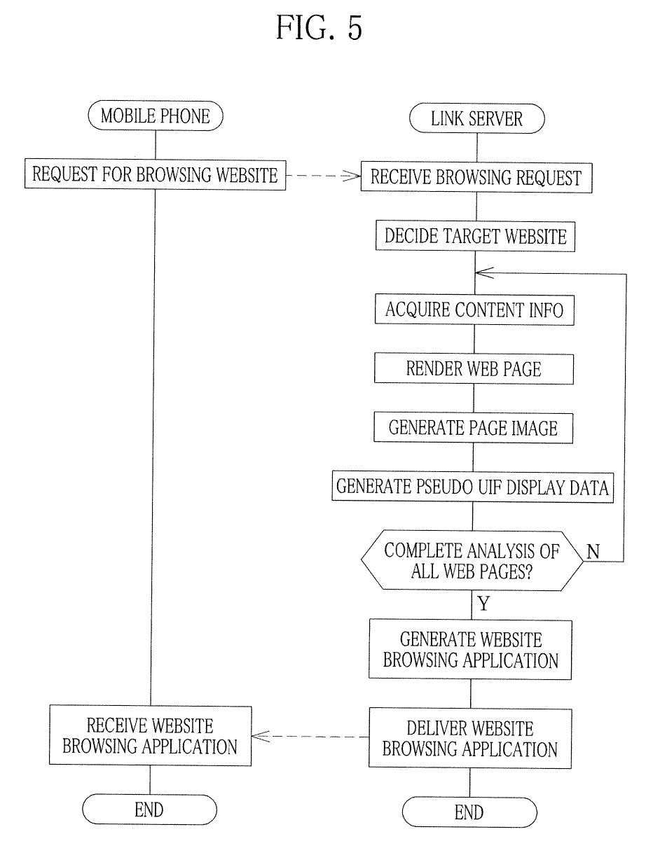

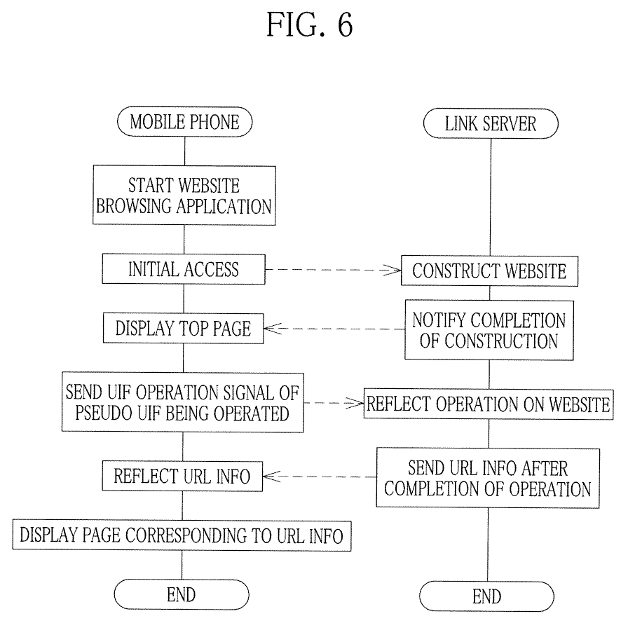

Next, an operation of the website browsing system 2 according to the above configuration is explained with reference to FIGS. 5 and 6. As shown in FIG. 5, when the website of the web server 7 is browsed on the mobile phone 3, the browser is started by operating the operation section 30, and the URL address of the top page of the desired website is sent to the link server 4 through the browser, and thereby requesting the link server 4 to allow a browse of the website.

When the browsing of the website is requested from the mobile phone 3, the CPU 40 of the link server 4 decides the target website based on the URL address included in the request. At the same time, the CPU 40 of the link server 4 accesses to the web server 7 corresponding to the URL address and acquires the content information 8 from the web server 7.

When acquiring the content information 8, the CPU 40 inputs the content information 8 to the web page analyzing section 43 and makes the web page analyzing section 43 render the web page 10 corresponding to the content information 8. After rendering the web page 10, the CPU 40 inputs the information about the web page 10 to the image converter 44, and thereby making the image converter 44 generate the page image 12 corresponding to the web page 10. At the same time, the CPU 40 inputs the information about the web page 10 to the UIF information analyzing section 45, and thereby making the UIF information analyzing section 45 generate the pseudo UIF display data 13 corresponding to each UIF 11 included in the web page 10.

The CPU 40 then performs the above-descried processing to each piece of content information 8 stored in the web server 7, and thus generating each page image 12 and each piece of pseudo UIF display data 13 for every web page 10 constituting the website of which the browsing is requested.

Once each page image 12 and each piece of pseudo UIF display data 13 are generated, the CPU 40 inputs the information to the application generating section 46 and instructs the application generating section 46 to generate the website browsing application 15. Upon receiving the instruction to generate the website browsing application 15 from the CPU 40, the application generating section 46 generates the URL information 16 based on the URL address of the top page included in the browsing request from the mobile phone 3. Then the CPU 40 encrypts each page image 12 and each piece of UIF display data 13, and incorporates them into the general-purpose application with the generated URL information 16. In this way, the website browsing application 15 is generated by combining each page image 12, each piece of UIF display data 13, the URL information 16 and the control code 17.

The CPU 40 then delivers the generated website browsing application 15 to the mobile phone 3 which has made the request. When the CPU 32 of the mobile phone 3 receives the website browsing application 15 from the link server 4, the CPU 32 stores the website browsing application 15 in the system memory 33.

As shown in FIG. 6, when the reception of the website browsing application 15 delivered from the link server 4 is completed, the website browsing application 15 is started by operating the operation section 30 of the mobile phone 3.

When the startup of the website browsing application 15 is instructed, the CPU 32 of the mobile phone 3 accesses to the system memory 33, reads the control code 17 included in the website browsing application 15, and starts the control according to the control code 17.

When the control according to the control code 17 is started, the CPU 32 first reads the URL information 16 included in the website browsing application 15 and sends the URL information 16 to the link server 4, thereby performing initial access which notifies the link server 4 of starting the browsing of the website by the website browsing application 15.

When the initial access is received from the mobile phone 3, the CPU 40 of the link server 4 accesses to the URL address indicated by the URL information 16 and acquires the content information 8 of the top page of the target website from the web server 7. Once the content information 8 is acquired, the CPU 40 inputs the content information 8 to the web page analyzing section 43 and makes the web page analyzing section 43 render the top page corresponding to the content information 8, thereby constructing the target website. The CPU 40 then sends a notice of completion of construction to the mobile phone 3.

Once the notice of completion of construction is received from the link server 4, the CPU 32 of the mobile phone 3 refers, based on the URL information 16, the header of each page image 12 and each piece of pseudo UIF display data 13 included in the website browsing application 15, and extracts the page image 12 and the pseudo UIF display data 13 corresponding to the top page of the target website.

Then, the CPU 32 displays the extracted page image 12 on the LCD 31. At the same time, the CPU 32 generates the pseudo UIF 14 corresponding to each piece of pseudo UIF display data 13 and superposes the generated pseudo UIF 14 at the corresponding position on the page image 12.

Since the initial access to the link server 4 is performed, and the page image 12 and the pseudo UIF 14 are displayed only when the notice of completion of construction is sent from the link server 4, the risk of the leakage of information like the website not accessible to the public can be further reduced.

After the page image 12 and the pseudo UIF 14 are displayed, the operation instruction can be input to the desired UIF 14 by operating the operation section 30. When the CPU 32 detects that the operation instruction is input, the CPU 32 generates the UIF operation signal indicating the operated pseudo UIF 14 and the content of the operation and sends the UIF operation signal to the link server 4 from the mobile phone 3.

When receiving the UIF operation signal, the CPU 40 of the link server 4 inputs the UIF operation signal to the UIF information analyzing section 45, thereby identifying the UIF 11 corresponding to the operated pseudo UIF 14, and makes the UIF information analyzing section 45 analyze the content of the operation. By sending the analysis result by the UIF information analyzing section 45 to the corresponding web server 7, the CPU 40 makes the operation instruction in the website browsing application 15 reflect on the actual website of the web server 7.

When the web content information 8 of another web page 10 in the website is delivered from the web server 7, the CPU 40 inputs the content information 8 to the web page analyzing section 43 and makes the web page analyzing section 43 render the web page 10 corresponding to the content information 8, and also sends the URL information 16 indicating the URL address of the web page 10 (content information 8) to the mobile phone 3 which has made the request.

When receiving the URL information 16 from the link server 4, the CPU 32 of the mobile phone 3 extracts the page image 12 and the pseudo UIF display data 13 on which the URL information corresponding to the received URL information is described in the header from the website browsing application 15, and makes the page image 12 display on the LCD 31. At the same time, the CPU 32 generates the pseudo UIF 14 corresponding to each piece of pseudo UIF display data 13 and superposes the generated pseudo UIF 14 at the corresponding position on the page image 12.

In this way, the website browsing application 15 is started on the mobile phone 3 and the control thereof is made based on the control code 17. Owing to this, the page image 12 and each pseudo UIF 14 can be displayed in the same manner as receiving the page image 12 and each piece of pseudo UIF display data 13 from the link server 4.

In addition, since the URL information 16 is combined, the relevancy between the website and the information such as the page image 12 and each piece of pseudo UIF display data 13 can be easily recognized by the mobile phone 3 and the link server 4 in a case of storing such information on the mobile phone 3. For this configuration, moreover, the functions related to the website browsing can be maintained as is the case of successively receiving the page image 12 and each piece of pseudo UIF display data 13 from the link server 4, and it is possible to reduce the communication wait time and communications cost when browsing the same website for more than two times.

Even if various types of information are stored on the mobile phone 3, the mobile phone 3 only controls based on the control code 17, and therefore requiring no complex processing such as association of each piece of information and the website. Accordingly, the delivery of the website in a form of application is especially beneficial in the system for the mobile phone 3 which has relatively low data processing capability.

According to the above embodiment, the website browsing application 15 is generated by incorporating each page image 12 and each piece of pseudo UIF display data 13. However, since the data volume of the pseudo UIF display data 13 is smaller than that of the page image 12, it has a relatively low effect on the communication wait time and communications cost even if the pseudo UIF display data 13 is received for each browsing.

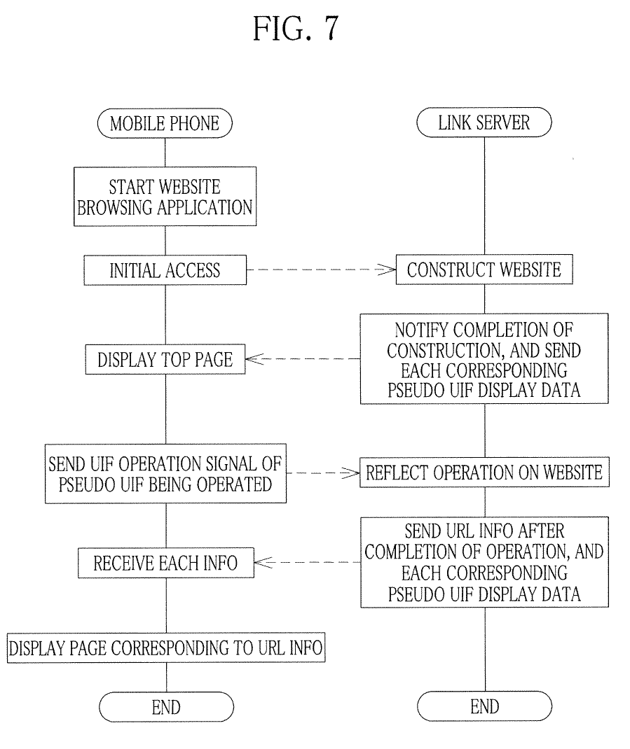

In view of this, it is possible that only each page image 12 and the URL information 16 are incorporated to the general-purpose application to generate the website browsing application 15. In this case, as shown in FIG. 7, each pseudo UIF display data 13 of the top page can be generated when the notice of completion of construction in response to the initial access is sent. It is also possible that each pseudo UIF display data 13 of the web page 10 corresponding to the URL information can be generated when the URL information is sent in response to the reception of the UIF operation signal.

For this configuration, the data size of the website browsing application 15 can be reduced, and therefore the communication wait time and communications cost can be reduced in delivering the website browsing application 15.

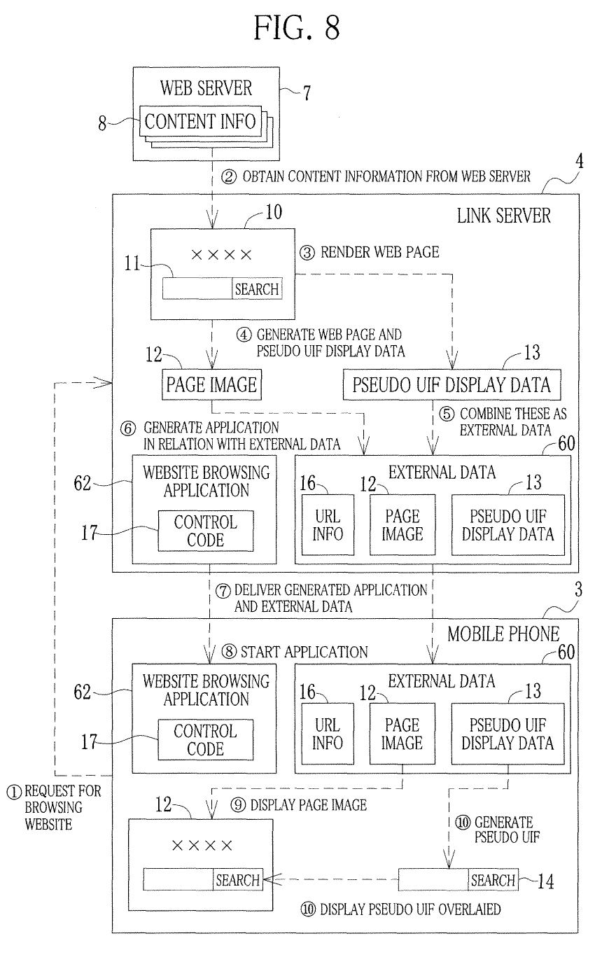

According to the above embodiments, the website browsing application 15 is generated by incorporating the generated page image 12 and pseudo UIF display data 13 into the general-purpose application. That is, the website browsing application 15 itself has the page image 12 and the pseudo UIF display data 13. The present invention is not limited to this, and may be configured as shown in FIG. 8.

In an example shown in FIG. 8, after each page image 12 and each piece of pseudo UIF display data 13 are generated, the CPU 40 of the link server 4 inputs the information to the application generating section 46 and instructs the application generating section 46 to generate an application.

According to the instruction from the CPU 40, the application generating section 46 generates the URL information 16 based on the URL address of the top page included in the browsing request from the mobile phone 3. The application generating section 46 then encrypts each page image 12 and each piece of UIF display data 13 so that they are decrypted only when an appropriate processing is performed based on the control code 17.

After the encryption, the application generating section 46 combines the encrypted page image 12 and pseudo UIF display data 13, and the URL information 16 as external data 60. The application generating section 46 associates a predetermined general-purpose application with the external data 60, and thereby combining the information as the external data 60 and the control code 17. Owing to this, a website browsing application 62 corresponding to the website to be browsed is generated. Note that the association can be made by giving common ID to the associated website browsing application 62 and each piece of information in the external data 60.

The CPU 40 delivers the generated website browsing application 62 and the corresponding external data 60 to the mobile phone 3 which has made the request.

When the reception of the website browsing application 62 is completed, the website browsing application 62 is started on the mobile phone 3. In response to the startup instruction, the mobile phone 3 reads the control code 17 included in the website browsing application 62. According to the description of the control code 17, each page image 12 included in the external data 60 associated to the website browsing application 62 is displayed on the LCD 31. At the same time, the pseudo UIF 14 corresponding to each piece of pseudo UIF display data 13 included in the external data 60 is generated and the generated pseudo UIF 14 is superposed at the corresponding position on the page image 12.

In this way, the similar effect as the above embodiment can be obtained in combining each page image 12 and each piece of pseudo UIF display data 13 as the external data 60 and delivering them in association with the website browsing application 62 to the mobile phone 3.

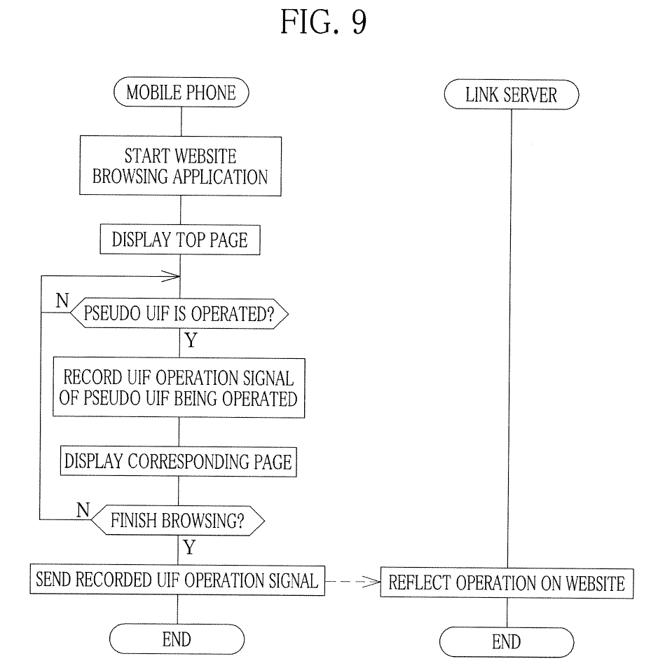

In the above embodiments, the UIF operation signal is sent to the link server 4 each time the pseudo UIF 14 is operated. It is also possible, as shown in FIG. 9, that when the pseudo UIF 14 is operated, the corresponding UIF operation signal is stored in the system memory 33 or the like, and the stored UIF operation signals are sent to the link server 4 all at once in response to the instruction to complete the browsing.

Although the risk of the leakage of information may rise for this configuration, the usability can be enhanced since the desired website can be browsed off-line, that is, when the mobile phone 3 cannot connect to the internet 5.

In the above embodiments, the network I/F 42 functions as the delivery section and delivers the website application 15 generated in the link server 4 to the mobile phone 3 via the internet 5. Instead, removable media such as SD card (trademark) may be used as the delivery section to deliver the website browsing application 15 to the mobile phone 3. It is also possible to use a cable for connecting the mobile phone 3 and the link server 4 as the delivery section.

In the above embodiments, although the website browsing application 15 is generated in the link server 4, the website browsing application 15 corresponding to the desired website may be generated by the PC owned by the user. In this caws, the generated website browsing application 15 may be installed on the mobile phone 3 by delivering it from the PC to the mobile phone 3 via the recording medium or cable.

In the above embodiments, the URL information 16 is used as the website information indicating that the website is targeted for browsing. Besides the URL information 16, an IP address of the web server 7 providing this website or any other information that enables identification of the website can be used.

In the above embodiments, the URL information 16 is used as the URL address of the top page of the target website and the website browsing application 15 is related to all of the web pages constituting the target website. Instead, the website browsing application 15 can be related to some of the web pages 10 of the target website.

In the above embodiments, although the mobile phone 3 is used as the mobile terminal, PHS or PDA, or other types of simple mobile computers like netbook may be used as the mobile terminal.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A link server being connected to a mobile phone and a web server through a network, said link server comprising:
a content information acquisition section for acquiring content information for constructing a web page of a website of which a browsing is requested from said mobile terminal;
a rendering section for rendering said web page from said content information;
an image converter for generating a page image corresponding to said web page by converting said web page into image data;
a pseudo UIF display data generating section for obtaining UIF information, which is for constructing a UIF in said web page, of every said UIF included in said web page from the rendering result of said web page, and generating, based on said UIF information, pseudo UIF display data for displaying a pseudo UIF having a comparable function as said UIF on said page image;
an application generating section for generating an application that enables a browse of content of said web page as said page image on said mobile terminal, said application having at least a control code for providing said mobile phone with a function to enable an input of an operation instruction as browsing the rendered web page by displaying said pseudo UIF on said page image; and
a delivery section for delivering said application, website information indicating said website to be browsed, said page image corresponding to this website, and corresponding said pseudo UIF display data to said mobile phone.

2. The link server according to claim 1, wherein said control code further providing said mobile phone with a function to send at least said website information to said link server, a function to make a display section of said mobile phone display said page image, and a function to input said operation instruction to said pseudo UIF through an operation section of said mobile phone.

3. The link server according to claim 2, wherein said application generating section includes said pseudo UIF display data in said application, and
said delivery section delivers said pseudo UIF display data as said application.

4. The link server according to claim 1, wherein said application generating section includes said website information and corresponding said web page in said application, and
said delivery section delivers said website information and said page image as said application.

5. The link server according to claim 1, wherein said application generating section combines said website information with corresponding said web page as external data, and
said delivery section delivers said application and said external data to said mobile phone.

6. The link server according to claim 5, wherein said application generating section encrypts said page image in combining said page image as said external data so that said page image is decrypted only when said application is started.

7. The link server according to claim 1, wherein said application displays said page image only when instructed by said link server.

8. A program of a link server being connected to a mobile phone and a web server through a network, said program making said link sever perform the steps of:
acquiring content information for constructing a web page of a website of which a browsing is requested from said mobile terminal;
rendering said web page from said content information;
generating a page image corresponding to said web page by converting said web page into image data;
obtaining UIF information, which is for constructing a UIF in said web page, of every said UIF included in said web page from the rendering result of said web page, and generating, based on said UIF information, pseudo UIF display data for displaying a pseudo UIF having a comparable function as said UIF on said page image;
generating an application that enables a browse of content of said web page as said page image on said mobile terminal, said application having at least a control code for providing said mobile phone with a function to enable an input of an operation instruction as browsing the rendered web page by displaying said pseudo UIF on said page image; and
delivering said application, website information indicating said website to be browsed, said page image corresponding to this website, and corresponding said pseudo UIF display data to said mobile phone.

9. A website browsing system, comprising:
(A) a mobile terminal for requesting a browse of a website; and
(B) a link server being connected to said mobile phone and a web server through a network,
said link server including:
a content information acquisition section for acquiring content information for constructing a web page of a website of which a browsing is requested from said mobile terminal;
a rendering section for rendering said web page from said content information;
an image converter for generating a page image corresponding to said web page by converting said web page into image data;
a pseudo UIF display data generating section for obtaining UIF information, which is for constructing a UIF in said web page, of every said UIF included in said web page from the rendering result of said web page, and generating, based on said UIF information, pseudo UIF display data for displaying a pseudo UIF having a comparable function as said UIF on said page image;
an application generating section for generating an application that enables a browse of content of said web page as said page image on said mobile terminal, said application having at least a control code for providing said mobile phone with a function to enable an input of an operation instruction as browsing the rendered web page by displaying said pseudo UIF on said page image; and
a delivery section for delivering said application, website information indicating said website to be browsed, said page image corresponding to this website, and corresponding said pseudo UIF display data to said mobile phone.

10. A website browsing method, comprising the steps of:
acquiring content information for constructing a web page of a website of which a browsing is requested from said mobile terminal;
rendering said web page from said content information;
generating a page image corresponding to said web page by converting said web page into image data;
obtaining UIF information, which is for constructing a UIF in said web page, of every said UIF included in said web page from the rendering result of said web page, and generating, based on said UIF information, pseudo UIF display data for displaying a pseudo UIF having a comparable function as said UIF on said page image;
generating an application that enables a browse of content of said web page as said page image on said mobile terminal, said application having at least a control code for providing said mobile phone with a function to enable an input of an operation instruction as browsing the rendered web page by displaying said pseudo UIF on said page image; and
delivering said application, website information indicating said website to be browsed, said page image corresponding to this website, and corresponding said pseudo UIF display data to said mobile phone.

11. A website browsing program for a mobile phone, said mobile phone being connected to a web server and a link server through a network,
said link server comprising:
a content information acquisition section for acquiring content information for constructing a web page of a website of which a browsing is requested from said mobile terminal;
a rendering section for rendering said web page from said content information;
an image converter for generating a page image corresponding to said web page by converting said web page into image data;
a pseudo UIF display data generating section for obtaining UIF information, which is for constructing a UIF in said web page, of every said UIF included in said web page from the rendering result of said web page, and generating, based on said UIF information, pseudo UIF display data for displaying a pseudo UIF having a comparable function as said UIF on said page image; and
a delivery section for delivering said page image and said pseudo UIF display data to said mobile phone,
said website browsing program making said mobile terminal realize the functions of:
(A) holding website information indicating said website to be browsed and said page image corresponding to this website;
(B) sending said website information to said link server;
(C) making a display section of said mobile phone display said page image;
(D) generating said pseudo UIF based on said pseudo UIF display data, and superposing said pseudo UIF at a corresponding position on the page image; and
(E) inputting said operation instruction to said pseudo UIF through an operation section of said mobile phone.
